(19) United States
(12) Patent Application Publication
(10) Pub. No.: US 2026/0036549 A1
(43) Pub. Date: Feb. 5, 2026

(54) IMAGING DEVICE

(71) Applicant: NATIONAL TSING HUA UNIVERSITY, Hsinchu (TW)

(72) Inventor: TING-WEI WANG, Hsinchu (TW)

(73) Assignee: NATIONAL TSING HUA UNIVERSITY, Hsinchu (TW)

(21) Appl. No.: 19/282,502

(22) Filed: Jul. 28, 2025

(30) Foreign Application Priority Data
Jul. 31, 2024 (TW) 113128466

(51) Int. Cl. G01N 27/90

(52) U.S. Cl. CPC G01N 27/9006; G01N 27/9086

(57) ABSTRACT

The present invention provides an imaging device. The imaging device includes a coil array including a plurality of coils, and a control module coupled to the coil array. The control module includes an eddy current measurement unit and an imaging unit. The eddy current measurement unit is configured to drive the plurality of coils to perform an eddy current sensing measurement and acquire a plurality of eddy current sensing results. The imaging unit is configured to form an eddy current sensing image according to the plurality of eddy current sensing results.

### TECHNICAL FIELD

The present invention relates to an imaging device, in particular, an imaging device for conducting eddy current sensing measurements by a coil array.

### BACKGROUND

Medical images not only provide information for observed objects (such as lesions), but also present interactions between the observed objects and the surrounding tissues. Therefore, compared to sound information or other medical auxiliary information, people are more accustomed to using medical images, which provide a more comprehensive observation of the observed objects. With the invention of various medical applications for medical images, the way to obtain medical images is no longer limited to hospitals or clinics. In conventional technologies, medical images can be obtained through mechanisms such as portable ultrasound devices or devices with bioelectrical impedance mechanisms.

Taking ultrasound devices as an example, ultrasound devices are commonly used in clinical practice to image organs or tissues such as arteries, heart, and/or breasts, but not limit thereto. Ultrasound devices are capable of regularly tracking and/or monitoring health status of organs or tissues of a patient. For example, a carotid ultrasound device is configured to monitor blood vessel walls. However, the performance or efficiency of an ultrasound device is limited by the operator. The operator for an ultrasound device is required to have professional training; therefore, an ordinary person cannot operate an ultrasound device for long-term and/or real-time detection. In addition, ultrasound coupling agents are necessary to reduce differences in acoustic impedance while operating an ultrasound device. Yet, ultrasound coupling agents smeared on the skin of the patient may cause allergic reactions in some patients. Additionally, ultrasound coupling agents may harden or be insufficiently smeared, thereby affecting image quality. Therefore, ultrasound devices are not conducive to performing a long-term measurement. Furthermore, transducers or probes for the ultrasound devices are expensive. Accordingly, ultrasound devices are not conducive to promotion for home or personal use in consideration of cost.

Taking devices with bioelectrical impedance mechanisms as an example, an exemplary operation for deriving bioelectrical impedance is to attach electrodes onto/into the skin for injecting current to extract voltage thereto to measure the bioelectrical impedance. However, a common technical issue for biomedical impedance sensors/electrodes is that a high contact impedance between the skin and the electrodes set on thereto will reduce signal quality and affect the accuracy for monitoring physiological parameters. To reduce the high contact impedance, the electrodes must be tightly adhered to the skin. However, air gaps are easily formed at the junction of electrodes and skin under different curvatures in different parts of the human body. Inappropriate electrode settings will increase the contact impedance between the skin and the electrodes and cause the actual impedance values not to be derived. Furthermore, due to the high impedance of the body, the excitation current for deriving the biomedical impedance that enter the body will follow an isotropic path. An isotropic path is a current path with a lower impedance. Hence, the isotropic path of the excitation current will limit the imaging method to mechanisms of bioelectrical impedance at the superficial layer of the skin. Therefore, devices with bioelectrical impedance mechanisms are not conducive to imaging of deep arteries and/or organs in the body.

Therefore, there are many issues to be addressed in regard to imaging technologies.

### SUMMARY

Therefore, the present invention provides an imaging device to effectively overcome the issues encountered in conventional technologies.

More specifically, one of the objectives of the present invention is to provide an imaging device that is non-contact, no coupling agents needed, low cost, or that can correspond to deep targets.

In a specific embodiment, the present invention provides an imaging device. The imaging device includes a coil array including a plurality of coils, and a control module coupled to the coil array. The control module includes an eddy current measurement unit and an imaging unit. The eddy current measurement unit is configured to drive the plurality of coils to perform an eddy current sensing measurement and acquire a plurality of eddy current sensing results. The imaging unit is configured to form an eddy current sensing image according to the plurality of eddy current sensing results.

In an embodiment, the eddy current sensing measurement includes a first eddy current sensing measurement corresponding to a first transmission frequency to generate a first eddy current sensing image corresponding to a first depth.

In an embodiment, the eddy current sensing measurement further includes a second eddy current sensing measurement corresponding to a second transmission frequency to generate a second eddy current sensing image corresponding to a second depth, wherein the imaging unit is configured to form a depth image with depth values.

In an embodiment, each coil of the plurality of coils has a first coil unit and a second coil unit, wherein a first center of the first coil unit overlaps with a second center of the second coil unit.

In an embodiment, the control module further includes a coil selection unit configured to select one of the first coil unit and the second coil unit to perform the eddy current sensing measurement.

In an embodiment, the control module further includes a transmission frequency selection unit configured to select a transmission frequency for the eddy current measurement unit to drive the plurality of coils.

In an embodiment, the transmission frequency selection unit includes an adjustable passive component array coupled to the plurality of coils to adjust the AC characteristic of the plurality of coils.

In an embodiment, the control module further includes a channel selection unit coupled to the coil array and configured to select at least one coil of the plurality of coils to couple to the eddy current measurement unit.

In an embodiment, the channel selection unit includes a first direction selection unit and a second direction selection unit.

In an embodiment, each coil of the plurality of coils corresponds to a pixel coordinate of the eddy current sensing image.

In an embodiment, the coil array is a circular array.

In an embodiment, the eddy current measurement unit is further configured to perform a baseline calibration measurement to derive a baseline value, wherein the imaging unit calibrates the eddy current sensing image based on the baseline value.

As mentioned above, the eddy current sensing measurement performed by the coil array can be a non-contact measurement and does not require any coupling agent. In addition, the eddy current sensing measurement can reach different depths based on the emitted electromagnetic signals. Therefore, the eddy current sensing measurement is available for imaging of targets located in different depths of body. In terms of cost, coil arrays and control circuits can be implemented through various mature circuit manufacturing technologies, which can effectively control costs compared to the costs for ultrasonic probes. Therefore, the imaging device of the present invention is well-suited for applications in personal care or long-term and/or real-time monitoring.

### BRIEF DESCRIPTION OF THE DRAWINGS

The accompanying drawings are presented to help describe various aspects of the present invention. In order to simplify the accompanying drawings and highlight the contents to be presented in the accompanying drawings, conventional structures or elements in the accompanying drawings may be drawn in a simple schematic way or may be omitted. For example, a number of elements may be singular or plural. These accompanying drawings are provided merely to explain these aspects and not to limit them.

FIG. 1 is a schematic diagram of an imaging device according to an embodiment of the present invention.

FIG. 2 is a schematic diagram of forming a depth image according to an embodiment of the present invention.

FIG. 3 is a schematic diagram of a coil having a first coil unit and a second coil unit according to an embodiment of the present invention.

FIG. 4 is a schematic diagram of a control module including a coil selection unit according to an embodiment of the present invention.

FIG. 5A is a schematic diagram of a control module including a transmission frequency selection unit according to an embodiment of the present invention.

FIG. 5B is a schematic diagram of a circuit for changing the coil transmission frequency through complex excitation signals according to an embodiment of the present invention.

FIG. 5C is a schematic diagram of a circuit for changing the coil transmission frequency through an adjustable passive element array according to an embodiment of the present invention.

FIGS. 6A and 6B are schematic diagrams of a control module including a channel selection unit according to an embodiment of the present invention.

FIG. 7 is a schematic diagram of the implementation of a non-planar coil array according to an embodiment of the present invention.

FIG. 8 is a schematic diagram of the implementation of a circular coil array according to an embodiment of the present invention.

### DETAILED DESCRIPTION

Any reference to elements using terms such as “first” and “second” herein generally does not limit the number or order of these elements. Conversely, these names are used herein as a convenient way to distinguish two or more elements or element instances. Therefore, it should be understood that the terms “first” and “second” in the request item do not necessarily correspond to the same names in the written description. Furthermore, it should be understood that references to the first element and the second element do not indicate that only two elements can be used or that the first element needs to precede the second element. Open terms such as “include”, “include”, “have”, “contain”, and the like used herein means including but not limit to.

The term “coupled” is used herein to refer to direct or indirect electrical coupling between two structures. For example, in an example of indirect electrical coupling, one structure may be coupled with another structure through a passive element such as a resistor, a capacitor, or an inductor.

In the present invention, the term such as “exemplary” or “for example” is used to represent “giving an example, instance, or description”. Any implementation or aspect described herein as “exemplary” or “for example” is not necessarily to be construed as preferred or advantageous over other aspects of the present invention. The terms “about” and “approximately” as used herein with respect to a specified value or characteristic are intended to represent within a value (for example, 10%) of the specified value or characteristic.

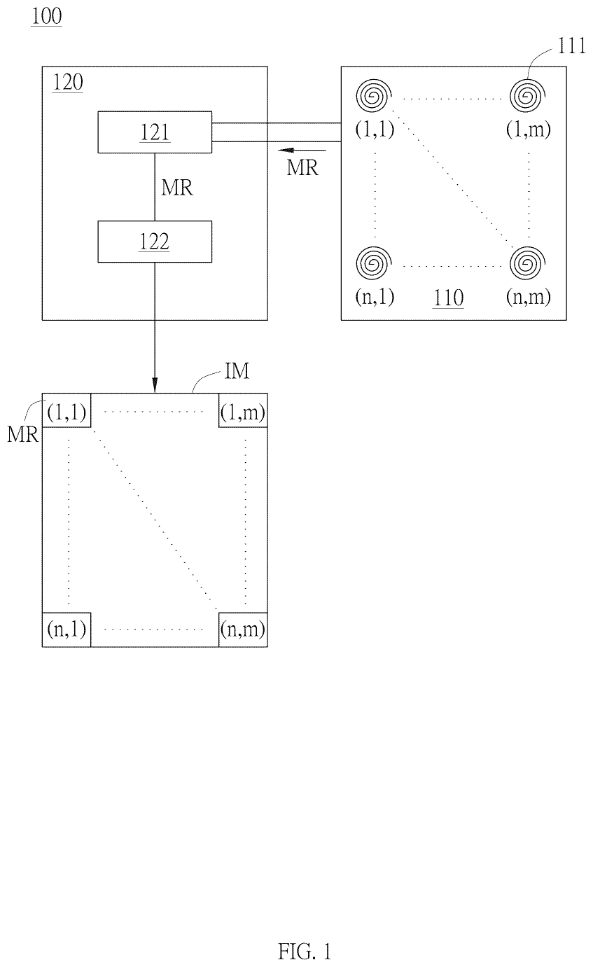

A specific embodiment of the present invention provides an imaging device. Referring to FIG. 1, FIG. illustrates an architecture diagram of the imaging device 100. The imaging device 100 includes a coil array 110 and a control module 120. The coil array 110 includes a plurality of coils 111. The control module 120 is coupled to the coil array 110 and includes an eddy current measurement unit 121 and an imaging unit 122. The eddy current measurement unit 121 is configured to drive the plurality of coils 111 to perform an eddy current sensing measurement to derive a plurality of eddy current sensing results (MR). The imaging unit 122 is configured to form an eddy current sensing image (IM) according to the plurality of eddy current sensing results (MR).

As shown in FIG. 1, the coil array 110 is an array formed by assembling a plurality of coils 111 (e.g. N×M coils). The plurality of coils 111 is preferably integrated on a flexible substrate to form the coil array 110. It should be noted that the formation of the coil array 110 is not limited by the setting means of the plurality of coils 111. In an embodiment, the coil array 110 is coated with biocompatible layers or films. For example, the material of the biocompatible layers or films may be polydimethylsiloxane (PDMS), SEBS, or biocompatible silicone. In the embodiment, the coil array 110 coated with the biocompatible layers or films may have structural characteristics of biocompatibility, waterproofness, and/or dust-proof properties, but not limited thereto. The structural characteristics of the coil array 110 coated with the biocompatible layers or films provide effects such as protecting the coil array 110 from the influence of external environment of the coil array 110 and minimizing the possibility of discomfort or allergies to the object to be tested during measurement.

In an embodiment, the coil array 110 includes a shielding element arranged between the coil array 110 and the control module 120. The shielding element provides effects such as reducing electromagnetic interference from the coil array 110 or the environment to the control module 120. Therefore, the shielding element arranged between the coil array 110 and the control module 120 will increase the effectiveness of magnetic coupling between the eddy current sensing measurement and the coil array 110, and improve the signal resolution and/or the signal-to-noise ratio during the eddy current sensing measurement performed by the coil array 110 and the control module 120.

The control module 120 may be, for example, a module composed of a programmable processor. The programmable processor may be, for example, a microprocessor, FPGA, ASIC, or SoC. The programmable processor is integrated with various units/components to form the control module 120. The control module 120 is configured to control the eddy current measurement unit 121 and the imaging unit 122. In an embodiment, the programmable processor is any user equipment (UE) having programmable functions such as a computer, a smartphone, or a laptop. In the embodiment, the units or components in the control module 120 can be discrete independent circuits, an integrated circuit or implementation from the internal components of a UE. As a specific example, a UE may be configured to perform eddy current sensing measurement with the coil array 110 by coupling with an external eddy current measurement unit 121 or by using the internal components of the UE. Then, the UE may be configured to use an external imaging unit 122 or the internal components of the UE (such as a graphics processing unit (GPU)) as the imaging unit 122 to generate the eddy current sensing image (IM) based on the results of the eddy current sensing measurement. By using a UE as the control modules 120, the imaging device 100 can be integrated with existing electronic products. Accordingly, the imaging device 100 is conducive to reducing costs and being used in personal applications or long-term monitoring applications.

In an embodiment, at least a portion of the control module 120 and the coil array 110 are encapsulated and/or integrated by biocompatible layers. More specifically, the control module 120 may be fully or partially encapsulated by biocompatible layers. In an embodiment, the portion of the control module 120 to be encapsulated may be the eddy current measurement unit 121. By encapsulating at least a portion of the control module 120 and the coil array 110 by the biocompatible layers, the overall moisture resistance of the control module 120 and the coil array 110 will be improved to prevent affecting the durability of the control module 120 and/or the coil array 110 by environmental factors (such as frequent alcohol disinfection). Thereby, the reliability of the imaging device 100 can be improved. In addition, in an embodiment, at least a portion of the control module 120 and the coil array 110 may be encapsulated by insulated layers to reduce the risk of electrical leakage and other electrical hazards. In an embodiment, the power supply for the encapsulated control module 120 and/or the encapsulated eddy current measurement unit 121 may be batteries with means for wireless charging.

The eddy current measurement unit 121 drives the plurality of coils 111 for the eddy current sensing measurement. Specifically, the plurality of coils 111 are configured to receive excitation signals from the eddy current measurement unit 121. The excitation signals excite the plurality of coils 111 to generate excitation electromagnetic signals based on electromagnetic effect. The electromagnetic signals from the plurality of coils 111 are configured to be emitted in the same direction or energy focusing to the test area. The blood or ionic liquid in the test area can be regarded as a planar conductor and will be stimulated by the electromagnetic signals to generate corresponding eddy currents. The generation of the eddy currents is related to the electrical characteristics of the area as a planar conductor. In other words, the generation of the eddy currents is related to the concentration or volume of blood or ionic liquids in the test area. More specifically, the pulsation of the blood vessels in the test area, the presence of a vascular embolism causing uneven blood flow velocity, and/or an abnormal concentration of blood vessels, such as in tumors, in the test area will affect the generation of eddy currents. The eddy current in the test area will generate feedback electromagnetic signals to the plurality of coils 111. When the plurality of coils 111 receive the feedback electromagnetic signals, the eddy current measurement unit 121 will measure at least one electrical characteristic of the plurality of coils 111 to generate corresponding eddy current measurement results (MR). It should be noted that the present invention is not limited to the excitation circuit architecture of the eddy current measurement unit 121. For example, the excitation circuit architecture of the eddy current measurement unit 121 may be configured to provide an AC signal to drive the plurality of coils 111 to generate the electromagnetic signals, or provide a DC signal to drive the plurality of coils 111 to generate electromagnetic signals through a DC-to-AC conversion component such as a resonant circuit.

After receiving the eddy current measurement results (MR) generated by the eddy current measurement unit 121, the imaging unit 122 form an eddy current sensing image (IM) based on the eddy current measurement results (MR) and the coordinate position of the plurality of coils 111 corresponding to the eddy current measurement results (MR). In other words, each of the plurality of coils 111 corresponds to a pixel coordinate of the eddy current sensing image (IM). The eddy current sensing image (IM) may be formed as a grayscale image or a color image. Each pixel of the grayscale image or the color image is configured to show the differences in electrical characteristic (such as resonant frequency changes or inductance changes) of the corresponding coordinate position of the plurality of coils 111 in the coil array 110. The grayscale image or the color image will help a viewer to identify, for example, a significant grayscale/color change area or an inconspicuous grayscale/color change area. The significant grayscale/color change area in the eddy current sensing image (IM) corresponds to significant changes in electrical characteristic. In an embodiment, the imaging unit 122 is a computer-readable medium that stores program instructions accessed by a GPU or a processor and cause the GPU or the processor to generate the eddy current sensing image (IM).

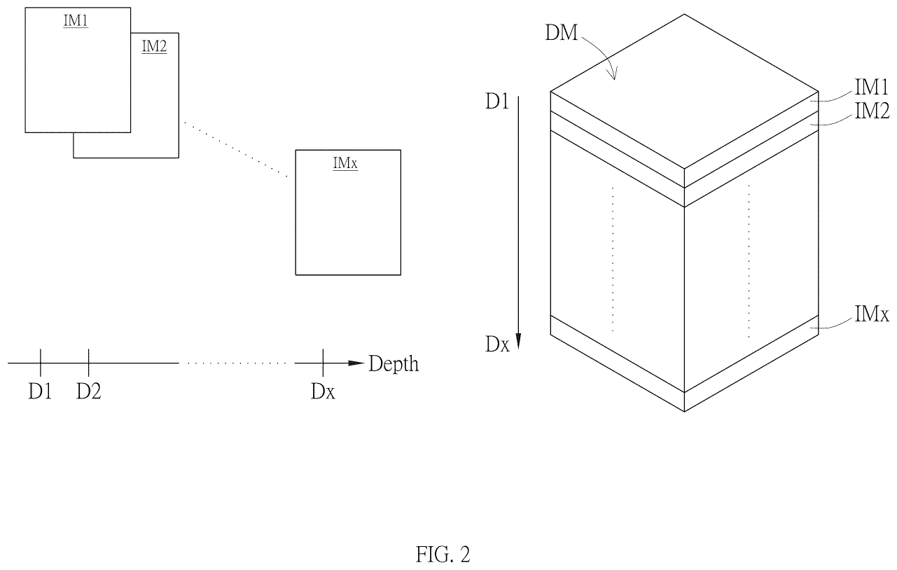

In an embodiment, referring to FIG. 2, the eddy current sensing measurement includes a first eddy current sensing measurement. The first eddy current sensing measurement corresponds to a first transmission frequency to generate a first eddy current sensing image (IM1) corresponding to a first depth (D1). Specifically, the plurality of coils 111 emit the excitation electromagnetic signals at a specific frequency to achieve an eddy current sensing measurement corresponding to a specific depth. In an embodiment, the eddy current sensing measurement further includes a second eddy current sensing measurement. The second eddy current sensing measurement corresponds to a second transmission frequency to generate a second eddy current sensing image (IM2) corresponding to a second depth (D2). In the embodiment, the imaging unit 122 is further configured to form a depth image (DM) based on depth values corresponding to the first eddy current sensing image (IM1) and the second eddy current sensing image (IM2), respectively. More specifically, the eddy current sensing measurements with different transmission frequencies will generate a plurality of eddy current sensing images (IM1-IMx) corresponding to different depths. The imaging unit 122 is configured to perform a reorganize operation, an overlap operation and/or a construction operation to superimpose the eddy current sensing images (IM1-IMx) based on the depth values (D1-Dx) to generate a depth image (DM) with depth values. Accordingly, the depth image (DM) helps the operator to identify the difference between the obvious and inconspicuous areas of eddy current generation, as well as the three-dimensional structure of the test area. The depth image (DM) also helps the operator, such as a non-professional, to understand the anatomical location of the obvious areas where eddy currents are generated. It should be noted that the present invention does not limit the relationship between the first transmission frequency and the second transmission frequency. More specifically, the first transmission frequency may be larger or small than the second transmission frequency to enable a plurality of eddy current sensing measurements from low depth to high depth or from high depth to low depth.

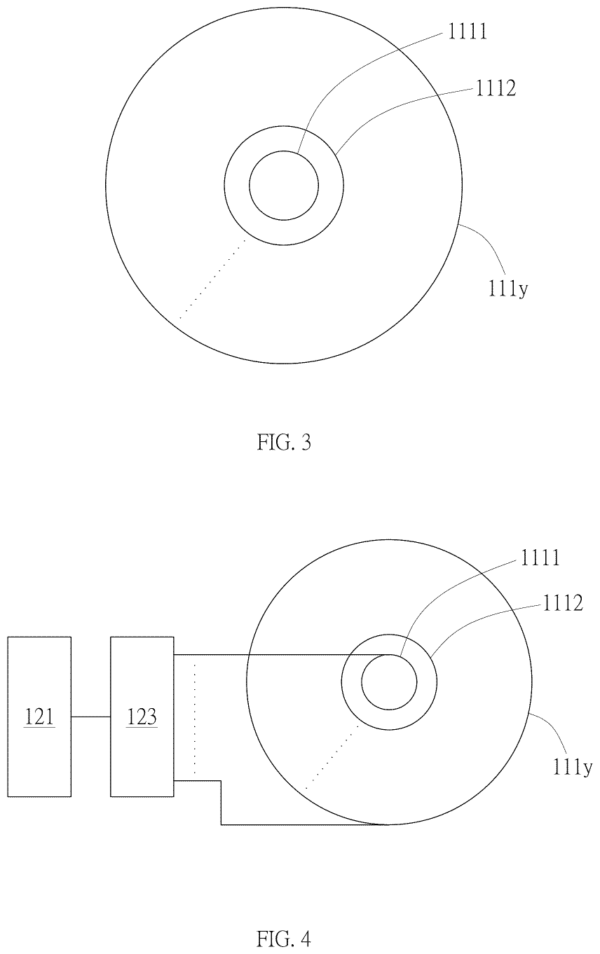

In an embodiment, referring to FIG. 3, each coil of the plurality of coils 111 includes a first coil unit 1111 and a second coil unit 1112 wherein the center of the first coil unit 1111 overlaps with the center of the second coil unit 1112. Specifically, the first coil unit 1111 and the second coil unit 1112 are configured to conduct eddy current sensing measurements with different transmission frequencies. Therefore, the first coil unit 1111 and the second coil unit 1112 are capable of emitting excitation electromagnetic signals with different transmission frequencies by, for example, switching between the first coil unit 1111 and the second coil unit 1112. In an embodiment, the first coil unit 1111 and the second coil unit 1112 are configured to have different inductance values or resonance frequencies. When the first coil unit 1111 and the second coil unit 1112 are excited by an AC signal, the first coil unit 1111 and the second coil unit 1112 will generate different excitation electromagnetic signals. Since the center of the first coil unit 1111 overlaps with the center of the second coil unit 1112, the generated excitation electromagnetic signals from the first coil unit 1111 and the second coil unit 1112, respectively, will act within a range but correspond to different depths. In an embodiment, the first coil unit 1111 and the second coil unit 1112 are configured to switch by means for switching. By switching between the first coil unit 1111 and the second coil unit 1112, the first coil unit 1111 and the second coil unit 1112 independently perform eddy current measurements to generate eddy current sensing images (IM1-IMx) corresponding to different depths. In an embodiment, the first coil unit 1111 and the second coil unit 1112 are configured to perform an overlapping eddy current measurement corresponding to a depth that is between the depth of using the first coil unit 1111 alone and the depth of using the second coil unit 1112 alone. For example, the first coil unit 1111 and the second coil unit 1112 are configured to perform eddy current measurements with different frequencies simultaneously. The detection depth of the first coil unit 1111 is at least in part overlaps with the detection depth of the second coil unit 1112. Therefore, the detection range of the overlapping eddy current measurement will cover the range between the detection depth of the first coil unit 1111 and the detection depth of the second coil unit 1112. Accordingly, it is possible for the present invention to correspond to multiple depths (D1-Dx) through fewer coil units (1111-111y) (i.e., y is less than x). It should be noted that the first coil unit 1111 and the second coil unit 1112 are not limited to the concentric circles shown in FIG. 3. In an embodiment, the first coil unit 1111 and the second coil unit 1112 may form a three-dimensional overlapping structure that generates different inductance values or resonance frequencies using different materials or other means. In this embodiment, referring to FIG. 4, the control module 120 preferably includes a coil selection unit 123. The coil selection unit 123 is configured to select one of the first coil unit 1111 and the second coil unit 1112 for performing eddy current sensing measurement. Specifically, the coil selection unit 123, such as a switch, multiplexer, or selector, is configured to select coil units according to a selection signal provided by a controller in the control module 120. It should be noted that FIG. 3 and FIG. 4 are illustrated using two coil units for the sake of simplicity. Generally, a person skilled in the art will know that the coil units in the coil array can be two or more, and the coil selection unit 123 is configured to have channels for switching between the two or more coil units.

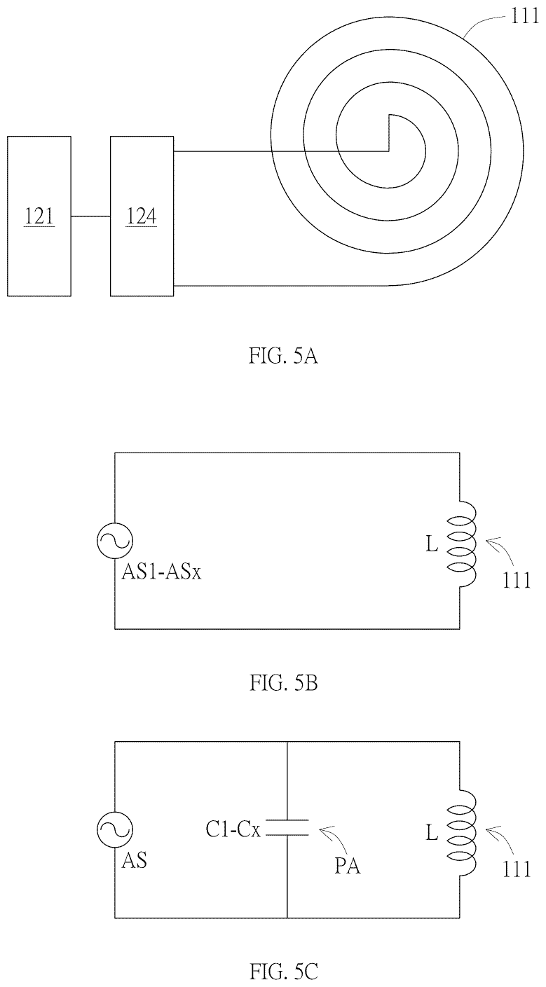

In an embodiment, referring to FIG. 5, the control module 120 further includes a transmission frequency selection unit 124. The transmission frequency selection unit 124 is configured to select the transmission frequency for driving the plurality of coils 111 to perform eddy current sensing measurements with the eddy current measurement unit 121. By using the transmission frequency selection unit 124, the transmission frequency during an eddy current sensing measurement can be adjusted to correspond to different depths. When the number of the transmission frequencies that can be selected by the transmission frequency selection unit 124 increases, the axial resolution of the depth image with depth values will also increase, reducing the problem of ghosting or misjudgment caused by insufficient eddy current sensing image (IM) in the depth image overlay.

In an embodiment, the exemplary selection mechanism of the transmission frequency selection unit 124 is shown in FIG. 5B. Referring to FIG. 5B, the transmission frequency selection unit 124 is configured to select the transmission frequency to the plurality of coils 111 for performing eddy current sensing measurements by changing the excitation signal of the eddy current measurement unit 121. More specifically, the eddy current measurement unit 121 is configured to be capable of providing multiple excitation signals (AS1-ASx). The excitation signals (AS1-ASx) provided to the plurality of coils 111 cause the plurality of coils 111 to emit excitation electromagnetic signals (ES1-ESx) with different emission frequencies. The transmission frequency selection unit 124 is configured to select from the excitation signals (AS1-ASx) the excitation signals needed according to, for example, the depth requirement. Therefore, eddy current sensing measurements corresponding to different depths are accomplished. Furthermore, a depth image with depth values is formed by the eddy current sensing measurements corresponding to different depths. By selecting from the excitation signals (AS1-ASx), the transmission frequency selection unit 124 provides effects, such as providing excitation signals that accurately correspond to target depths to improve the quality of the eddy current sensing image and/or the depth image of the present invention.

In an embodiment, the exemplary selection mechanism of the transmission frequency selection unit 124 is shown in FIG. 5C. Referring to FIG. 5C, the transmission frequency selection unit 124 includes an adjustable passive element array (PA) which is coupled to the plurality of coils 111 and configured to adjust the AC characteristics of the plurality of coils 111. Specifically, the adjustable passive element array (PA) is configured to change the resonance frequency of the LC circuit composed of the plurality of coils 111 and a capacitor. Referring to FIG. 5C, the example shown in FIG. 5 illustrates the adjustable passive element array (PA) that can be a variable capacitor with capacitance values (C1-Cx), but not limited thereto. Any passive component that is capable of adjusting the resonance frequency of the LC circuit of the plurality of coils 111 should be within the scope of the embodiment. By using an adjustable passive component array (PA), the excitation signal of the eddy current measurement unit 121 can be adjusted through hardware means, and simplify the circuit of the eddy current measurement unit 121 without the need for precise signal generation and frequency control methods to adjust the frequency of the excitation electromagnetic signal.

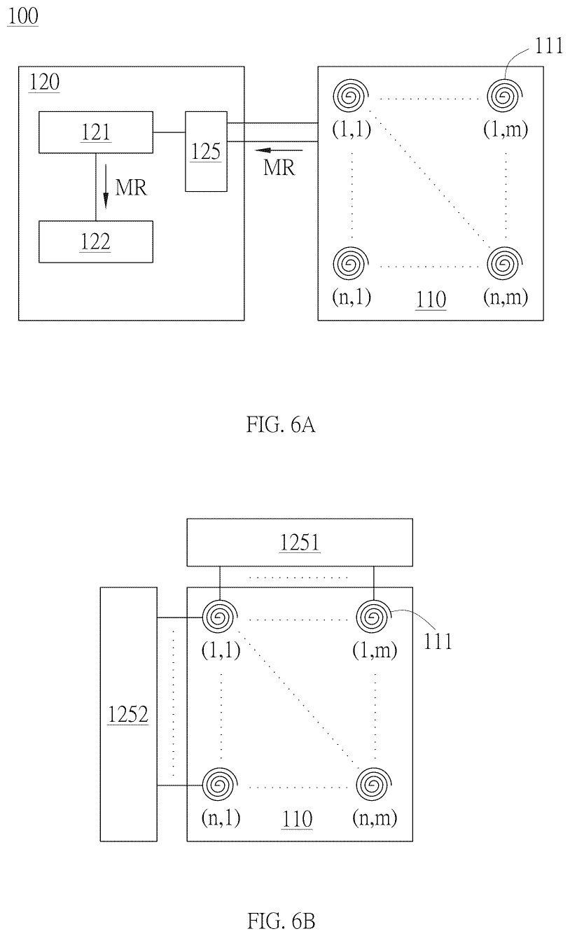

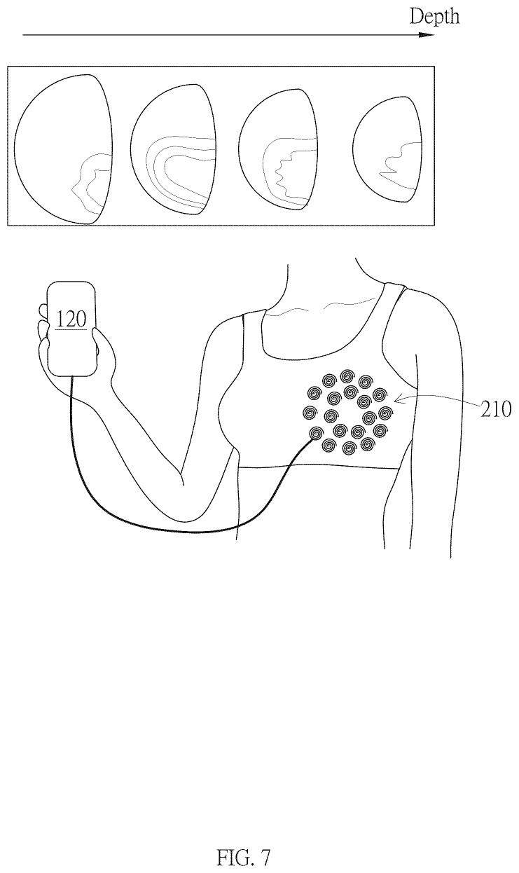

In an embodiment, referring to FIG. 6A, the control module 120 further includes a channel selection unit 125 coupled to the coil array 110 and configured to select at least one coil of the plurality of coils 111 to be coupled to the eddy current measurement unit 121 for conducting eddy current sensing measurements. The channel selection unit 125 may be, for example, a switch control component such as a multiplexer, selector, switch, or transistor. The channel selection unit 125 connects to the selected coil of the plurality of coils 111 that perform the eddy current sensing measurement with the eddy current measurement unit 121 to receive the excitation signal from the eddy current measurement unit 121. By using the channel selection unit 125, the number of coils required for conducting an eddy current sensing measurement can be reduced, the circuit may be simplified, and the emitted electromagnetic wave energy can be reduced. Performing an eddy current measurement by selecting a part of the plurality of coils 111 will also reduce interference between the coils. For example, eddy current sensing measurements can be performed simultaneously on coils of the plurality of coils 111 that are farther apart. When eddy currents are generated, the farther apart the coils used for the eddy current sensing measurements, the less likely the coils will interfere with each other and affect the measurement results. In an embodiment, the channel selection unit 125 can also enable the plurality of coils 111 to perform eddy current sensing measurement in a grouped manner. The grouped manner for the plurality of coils 111 provides effects that achieve the purpose of scanning or sensing sequentially. However, the purpose of setting the channel selection unit 125 in the present invention is not limited thereto.

In an embodiment of the channel selection unit 125, the channel selection unit 125 may include a first direction selection unit 1251 and a second direction selection unit 1252. Specifically, referring to FIG. 6B, the channel selection unit 125 may include the first direction selection unit 1251 corresponding to, for example, the row direction of the coil array 110, and the second direction selection unit 1252 corresponding to, for example, the column direction of the coil array 110. By using the first direction selection unit 1251 and the second direction selection unit 1252, the first direction selection unit 1251 and the second direction selection unit 1252 provide a specific coil position of a selected coil in the coil array 110 for emitting inductive electromagnetic signal, and an accurate selection and/or control to the channel selection unit 125. Furthermore, the first direction selection unit 1251 and the second direction selection unit 1252 provide effects such as effectively reducing the number of channels required for the channel selection unit 125. Therefore, the number of components or channels for the channel selection unit 125 to regulate the plurality of coils 111 can be reduced.

It should be noted that the coil array is not limited to a planar array form shown in FIG. 1. In an embodiment, referring to FIG. 7, a non-planar coil array 210 is provided. The non-planar coil array 210 is formed by arranging the plurality of coils 111 on the test area (such as breast skin). In an embodiment, the eddy current sensing image (IM) is not limited to section images. For example, as shown in FIG. 7, the eddy current sensing image (IM) can be layer images with different depths of the test area from the surface of the test area to inside of the test area. By using the non-planar coil array 210 attached on the surface of the test area, an eddy current sensing image (IM) is form by the layer images to provide a 3D image of the test area. In addition, in an embodiment, the position or arranging site of each coil in the non-planar coil array 210 may be located by a motion capture or position locator. The motion capture or the position locator are configured to locate the relative position of the plurality of coils 111 arranged on the surface of the test area. By deriving/locating the relative position of the plurality of coils 111, the position information provided by the motion capture or position locator based on the relative position of the plurality of coils 111 may be used to form a 3D image of the test area by overlapping the layer images at different depths of the test area.

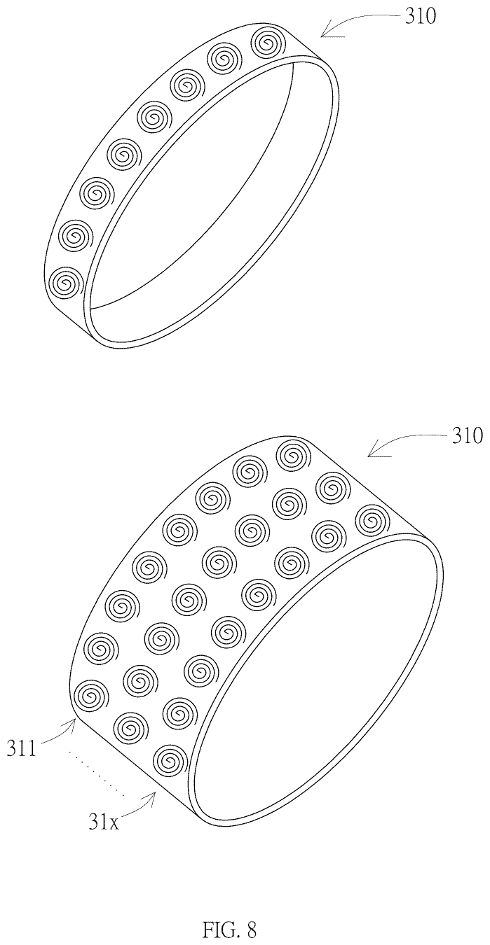

In an embodiment of the coil array of the present invention, the coil array is a circular array. Specifically, referring to FIG. 8, the plurality of coils 111 are arranged in sequence according to a circular coil arrangement 310. The plurality of coils 111 arranged according to the circular coil arrangement 310 are configured to perform an eddy current sensing measurement to the test area located in the center of the circular coil arrangement 310 to obtain images of different depth layers of the test area. It should be noted that the present invention is not limited to the ring number of the circular coil arrangement 310. For example, in an embodiment, a cylindrical annular array may be formed by the circular coil arrangement 310 with a plurality of ring 311-31x. Through the cylindrical annular array, 3D columnar images with different depth layers of the test area can be obtained. In an embodiment, the plurality of ring 311-31x are configured to perform eddy current measurements simultaneously or not simultaneously. For example, the plurality of ring 311-31x are configured to perform eddy current measurements simultaneously to achieve scanning or equivalent effects. In an embodiment, the eddy current generation state or conductivity distribution within the test area (such as tumors or blood vessels) measured by the circular coil arrangement 310 is inferred through inverse problems or other methods based on the measurement signals received by each coil of the plurality of coils 111 to directly obtain a 3D image of the test area.

In an embodiment, the eddy current measurement unit is further configured to obtain baseline values of the eddy current measurement for baseline correction, wherein the imaging unit corrects the eddy current sensing image based on the baseline values. Specifically, before or after conducting the eddy current sensing measurement, the eddy current measurement unit may be configured to emit reference electromagnetic signals for baseline correction measurement by using the coil array 110. In the baseline calibration measurement, the reference electromagnetic signal measurement results are predictable or can be pre-set compared to the excitation electromagnetic signal system. For example, the reference electromagnetic signal does not cause any eddy current interaction or simply cause a predictable interaction in the test area. Therefore, the baseline values for the baseline calibration measurement can be obtained. Specifically, external factors (e.g. the state or quality of each object, environment, and/or the coil array under test) may cause bias in the eddy current sensing measurement. By using the baseline correction measurements with predictable results, the level of deviation between the current measurement results and the predicted baseline values can be determined. By correcting the level of offset, artifacts or noises caused by the external factors during each measurement can be effectively minimized. In an embodiment, the imaging unit is further configured to normalize each generated eddy current sensing image to a normal baseline based on the baseline value to reduce imaging errors. It should be noted that the reference electromagnetic signal is one or more sets of different frequencies. For example, multiple sets of reference electromagnetic signals can be used to calibrate within the reference interval. Therefore, in addition to the offset baseline, it can also be used to calibrate the scaling ratio of the baseline.

The imaging device proposed by the present invention can be used, for example, for physiological monitoring. By using coils to emit excitation electromagnetic signals, eddy currents are induced in areas with different impedances such as tumors, blood vessels, or organs in the test area. The generation of eddy currents varies due to impedance or conductivity caused by various physiological conditions (such as pulse or tumor formation) in the test area. The differential eddy currents cause the coil to receive feedback electromagnetic signals that are different, and the measurement results are imaged through the operation of the imaging unit. The imaging device induced by eddy current can be non-contact and does not require any coupling agent. In addition, eddy current induction can reach different depths based on the electromagnetic signals it emits, allowing for imaging of targets at different depths. In terms of cost, coils and control circuits can be implemented through various mature circuit manufacturing technologies, which can effectively control costs compared to the costs for ultrasonic probes. Therefore, the imaging device of the present invention is well-suited for applications in personal care or long-term and/or real-time monitoring.

The aforementioned description of the present invention is provided to enable a person of ordinary skill in the art to make or implement the present invention. Various modifications to the present invention will be apparent to a person skilled in the art, and the general principles defined herein can be applied to other variations without departing from the spirit or scope of the present invention. Therefore, the present invention is not intended to be limited to the examples described herein, but is to be in accord with the widest scope consistent with the principles and novel features of the invention herein.

What is claimed is:

1. An imaging device comprising:
a coil array including a plurality of coils; and
a control module coupled to the coil array, the control module including:
an eddy current measurement unit configured to drive the plurality of coils to perform an eddy current sensing measurement and acquire a plurality of eddy current sensing results; and
an imaging unit configured to form an eddy current sensing image according to the plurality of eddy current sensing results.

2. The imaging device of claim 1, wherein the eddy current sensing measurement includes a first eddy current sensing measurement corresponding to a first transmission frequency to generate a first eddy current sensing image corresponding to a first depth.

3. The imaging device of claim 2, wherein the eddy current sensing measurement further includes a second eddy current sensing measurement corresponding to a second transmission frequency to generate a second eddy current sensing image corresponding to a second depth; and wherein the imaging unit is configured to form a depth image with depth values.

4. The imaging device of claim 1, wherein each coil of the plurality of coils has a first coil unit and a second coil unit; and wherein a first center of the first coil unit overlaps with a second center of the second coil unit.

5. The imaging device of claim 4, wherein the control module further includes a coil selection unit configured to select one of the first coil unit and the second coil unit to perform the eddy current sensing measurement.

6. The imaging device of claim 1, wherein the control module further includes a transmission frequency selection unit configured to select a transmission frequency for the eddy current measurement unit to drive the plurality of coils.

7. The imaging device of claim 6, wherein the transmission frequency selection unit includes an adjustable passive component array coupled to the plurality of coils to adjust an AC characteristic of the plurality of coils.

8. The imaging device of claim 1, wherein the control module further includes a channel selection unit coupled to the coil array and configured the select at least one coil of the plurality of coils to couple to the eddy current measurement unit.

9. The imaging device of claim 8, wherein the channel selection unit includes a first direction selection unit and a second direction selection unit.

10. The imaging device of claim 1, wherein each coil of the plurality of coils corresponds to a pixel coordinate of the eddy current sensing image.

11. The imaging device of claim 1, wherein the coil array is a circular array.

12. The imaging device of claim 1, wherein the eddy current measurement unit is further configured to perform a baseline calibration measurement to derive a baseline value; and wherein the imaging unit calibrates the eddy current sensing image based on the baseline value.
